(19) United States
(12) Patent Application Publication
(10) Pub. No.: US 2017/0242966 A1
(43) Pub. Date: Aug. 24, 2017

(54) METHOD FOR PREDICTING PATIENT MOVEMENT

(71) Applicant: De Leon Medical Logistics, LLC, Davidson, NC (US)

(72) Inventors: Ricardo de Leon, Davidson, NC (US); Mahdi Ajjan, Davidson, NC (US)

(21) Appl. No.: 15/440,239

(22) Filed: Feb. 23, 2017

Related U.S. Application Data
(60) Provisional application No. 62/298,618, filed on Feb. 23, 2016.

(51) Int. Cl. G06F 19/00

(52) U.S. Cl. CPC G06F 19/345; G06F 19/3406

(57) ABSTRACT

A method for predicting patient movements such that injury or patient can be avoided. The method includes the steps of: monitoring a first patient such that data related to predetermined factors is collected to form a data set; comparing the data set to a patient profile; and identifying a state of the first patient based on the patient profile.

### BACKGROUND OF THE INVENTION

The present invention relates to monitoring physiological data of patients and more specifically to a method for predicting the occurrence of particular patient movements in advance.

It is believed that the number of patients in healthcare facilities in the U.S. is increasing as the population in the U.S. grows older. Care for patients in healthcare facilities involves careful attention to the patient. Such careful attention is required because many of these patients need assistance in daily activities or because their pain level is increasing. The daily activity can include repositioning themselves in bed, relieving themselves either through urination or defecation, and getting out of or into bed. It is advantageous to provide assistance or medication in a timely manner in order to avoid situations where the patient may be injured, such as by falling, or soiled, such as by defecation. Failure to provide such assistance can result in injuries or death.

In addition to patients at healthcare facilities, more people are requiring assistance with activities of daily living at home either by their loved ones or by in-home healthcare workers. These homebound patients should benefit from the same attention and help as those in healthcare facilities.

One problem with conventional methods for monitoring patients is that they do not predict when bodily functions will occur and/or when pain control is required. They also do not predict when urination or defecation will occur. As a result, help for a patient can often be provided only after the fact.

Another problem associated with conventional methods for monitoring patients is that they do not predict when a patient might leave a bed. For many patients leaving a bed unassisted greatly increases the chance of an injury related to fall. Healthcare facilities and healthcare providers are generally unable to observe the patient around the clock and thus sometimes miss indications that a patient is about to leave the bed. Consequentially sometimes a patient does leave the bed unaccompanied and falls.

One problem with bedridden patients is that there is a direct relationship between urine and fecal incontinence and decubitus ulcers. It is believed that this direct relationship is due to moisture and contaminants associated with a soiling event. As used herein, the term “soiling event” refers to times when a patient defecates or urinates in an uncontrolled manner such that the patient dirties themselves or associated bed linens.

Conventionally, in order to best provide help to patients a healthcare facility must rely on observations and attention provided by facility staff such as aides, porters, nurses, and doctors. However it is expensive and difficult to staff facilities with enough support personnel to provide adequate monitoring of patients. As a result, there is a need for accurate monitoring in an aging and bedridden population.

One problem with conventional devices for monitoring health and well-being of patients is that such devices are not capable of predicting a particular behavior prior to its occurrence. Therefore there is a broad usefulness for devices that can collect, measure, calculate, and ultimately predict behaviors prior to their occurrence.

Another problem related to medical care nursing homes and assisted living settings is the potential overuse of pain medications such as narcotics. It is believed that accurate impulse monitoring and frequent data collection utilizing the present invention to correlate body movements to pain medication will assist in the reduction of pain medication overuse and create certainty that pain relief is being provided.

Another problem in nursing homes and assisted living settings is that demented and nonverbal patients can have difficulty conveying their needs. Therefore there is a need for making it possible for such persons to be attended to and understood.

### SUMMARY OF THE INVENTION

According to one aspect of the present invention, there is provided method for predicting patient movements such that injury or patient can be avoided. The method includes the steps of: monitoring a first patient such that data related to predetermined factors is collected to form a data set; comparing the data set to a patient profile; and identifying a state of the first patient based on the patient profile.

### DETAILED DESCRIPTION OF THE INVENTION

The present invention provides a monitoring system configured to monitor human body movement. The monitoring system includes a computing device, an operator interface with the computing device, at least one data collection device, a computer processor and software for processing collected data. The data collection devices are configured to communicate with the computing device via a data connection. Such a connection can be wired, wireless, optical, or other means for conveying signals from data collection devices to the computing device. By way of example and not limitation, the data collection device can be configured to determine one of the following: temperature, pressure, acceleration, weight, air pressure, changes in air pressure, fluid pressure, and a combination thereof. By way of example and not limitation, physiological characteristics that can be monitored include temperature, heart rate, blood pressure, the presence or absence of feces, presence or absence of urine, respiration rate, movement of limbs, movement of muscles, and a combination thereof.

The collection device is configured to send data to the computer processor. The computer processor is a HIPPA compliant hub. The data is plotted and interpreted. Such data manipulation is done by software, but could be done manually. Collection of data is used to track nonverbal, verbal, patient movements, and other information to determine the intentions and needs of minimally communicative patients. Over time movements of minimally communicative patients can be predicted based on comparison of current data with historical data.

According to one embodiment of the present invention there is provided a computing hub. The computing hub is connected to monitors via low-frequency signal such as Bluetooth. In this embodiment, a hub is positioned within 100 feet of the person being monitored. It should be appreciated that in other embodiments hubs are positioned further away from a patient being monitored. The monitoring device includes a thin pad that monitors humidity as well as monitoring movement at various increments and sensitivity levels.

Other monitoring points can also be connected to the hub. The hub can be configured to collect information from multiple data collection inputs for a single subject or patient. The hub can also be configured to collect information from multiple subjects or patients all of which have multiple data collection inputs being monitored. Data such as that related to humidity and movement and frequency of the former can be collected.

Data collected by the hub is then transferred to another computing center. This computing center can collect information from multiple hubs. This computing center is configured to produce endpoint information. As used herein, the term “endpoint information” refers to information that will be used to predict behavior of a patient. Such information could be derived from data collected by the present invention. For example, endpoint information can include averages of patient temperature over certain periods of time or at certain times of the day.

Both the hub and the network computer can be configured to produce endpoint information in the illustrated embodiment, the network computer is configured to produce endpoint information. The endpoint information is analyzed to determine a patient's activity and actions and is correlates that action to nonverbal cues. In this way a patient profile is developed that includes data related to particular states. Thus physical cues related to particular patient movements can be identified.

The endpoint information is plotted over time with information related to intensity and frequency. Patient physical cues are then marked. Such physical cues can include loss of bowel control, seizures, etc. The determination of presence of a rhythmic pattern is made. The rhythmic pattern can be used as an identifier of a profile which can be used to prevent unnecessary bedsores, and to control pain.

It should be noted that the longer a patient is on a device, the longer data is collected for that patient. As a result, more data will be plotted. Such an increase in data results in a truly individualized system that is custom tailored to each individual the longer it is used. During the initial phase of use there is an elevated need for technician to correlate a data point or data points with an action. The data point can be an endpoint information as described above.

Once more data is collected, a profile can be formed by the software. Future data that is monitored from a first, or particular, patient is compared to the profile. In this manner, predictions of when a patient is likely to exhibit one of the actions described above can be made. When the computer and software make such a prediction, the operator can be signaled or otherwise alerted through the operator interface that the patient is about to have an action occur. This allows the operator, or caregiver, to provide help to the patient in advance of an event or detrimental occurrence taking place.

In accordance with the illustrated embodiment, a patient is categorized as being in one of two primary predetermined states. They are: normal or preliminary agitation. During the normal state, the patient can be sleeping, awake, eating, or otherwise remaining in bed. While in the normal state, the patient does not need additional care from attendants because the patient is not likely to experience an event. During the preliminary agitation state, the patient is exhibiting physical cues that an event is likely to take place.

When the monitored data reflects a preliminary agitation state, the device provides a signal to alert the attendant that additional care or supervision is likely to b be needed by the patient. The preliminary agitation state can be further categorized as being predictive of a particular type of patient movement as identified by a particular related data profile. By way of example and not limitation, such profiles include: pre-defecation, pre-urination, pre-excessive movement, pre-bed exiting, increasing pain, and the like.

To determine which predetermined state that a patient is in, incoming data is compared to a patient profile stored in the computer processor. The patient profile can be based on a generic profile developed by observing a large number of patients to identify common indicators of a predetermined state. Alternatively, the patient profile can be based on an individual profile of that particular patient. Such a profile can be developed when a patient is initially under care during an observation phase. During this observation phase, the generic profile can be used to care for the patient and predict their movements. When developed, the individual profile can replace the generic profile.

Through the profiles, the predetermined states are associated with particular physical cues. These physical cues can be related to particular physiological traits such as electrical neurological signals, heart rate, blood pressure, limb movement or the like. For example the pre-defecation state can be indicated by a predetermined number of abdominal spasms over a predetermined period of time, i.e., a rate of bowel spasms. The pre-bed exiting state can be indicated by a particular pattern of weight-shifting or limb movement.

As used herein, the term “measuring device” refers to a communication enabled device with lithium-ion battery for extended life, low-key production and consistent energy source. Consisting of a “memory foam” pad to become sculpted to each individual's body. Such sculpting reduces unnecessary pressure. This pad is also perforated in multiple directions reducing the capture of heat and humidity. This will reduce tissue insult and elevated humidity false alarms. Increased levels of humidity can also be used to remind staff when a patient needs to be moved.

As used herein, the term “hub” refers to a receiving device configured to collect all data points. As indicated above, such data points are generated by stimulation produced by the patient. Double is configured to translate the data points and information that can be measured and plotted.

As used herein, the term “network” refers to an interlinked system between all associated hubs configured to share information bidirectionally.

As used herein, the term “endpoint information” refers to collection of data from the measuring device that is transmitted to the hub via the network and finally results in a measurable data point.

The foregoing has described an apparatus and method for monitoring patients and predicting movements such as bodily functions based on nonverbal cues. It is believed that monitoring patients in the as described above would decrease overall health care costs and at the same time reduce morbidity. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying potential points of novelty, abstract and drawings), or to any novel one, or any novel combination, of the steps of any method or process so disclosed.

What is claimed is:

1. A method for predicting patient movements such that injury or patient can be avoided, the method including the steps of:
monitoring a first patient such that data related to predetermined factors is collected to form a data set;
comparing the data set to a patient profile; and
identifying a state of the first patient based on the patient profile.

2. The method for predicting patient movement according to claim 1, further comprising the step of:
generating an attendant readable signal indicating the state of the patient.

3. The method for predicting patient movement according to claim 2, further comprising the step of:
responding to the signal.

4. The method for predicting patient movement according to claim 1, wherein the step of identifying the state of the first patient includes the step of predicting future movement of the first patient.

5. The method for predicting patient movement according to claim 1, wherein the patient profile is determined based on data collected from multiple patients.

6. The method for predicting patient movement according to claim 5, wherein the patient profile is determined based in part on data collected from the first patient.

7. The method for predicting patient movement according to claim 1, wherein the patient profile is determined based on data collected from the first patient.

8. The method for predicting patient movement according to claim 1, wherein the patient state is one of the following: normal and preliminary agitation.

9. The method for predicting patient movement according to claim 8, wherein the preliminary agitation state is identified as being one of the following: pre-defecation, pre-urination, pre-excessive movement, pre-bed exiting, increasing pain, and a combination thereof.

10. The method for predicting patient movement according to claim 9, wherein the signal includes information identifying the at least one preliminary agitation state.
